(19) United States
(12) Patent Application Publication
(10) Pub. No.: US 2024/0173105 A1
(43) Pub. Date: May 30, 2024

(54) INDIRECT BONDING TRAYS WITH BITE TURBO AND ORTHODONTIC AUXILIARY INTEGRATION

(71) Applicant: Swift Health Systems Inc., Irvine, CA (US)

(72) Inventors: Hongsheng Tong, Yorba Linda, CA (US); Robert Lee, Torrance, CA (US); Andre Weissheimer, Irvine, CA (US)

(21) Appl. No.: 18/529,225

(22) Filed: Dec. 5, 2023

Related U.S. Application Data
(63) Continuation of application No. 17/672,083, filed on Feb. 15, 2022.
Application No. 17/672,083 is a continuation of application No. 16/804,734, filed on Feb. 28, 2020, now abandoned.
(60) Provisional application No. 62/812,609, filed on Mar. 1, 2019.

(51) Int. Cl. A61C 7/14

(52) U.S. Cl. CPC A61C 7/146

(57) ABSTRACT

An orthodontic indirect bonding tray that may transfer orthodontic brackets, bite turbo, and/or orthodontic auxiliaries is disclosed. The indirect bonding tray may be digitally designed and 3D printed or fabricated based on a bonding model. The indirect bonding tray may transfer the orthodontic brackets, bite turbos, and orthodontic auxiliaries to any tooth surface. The indirect bonding tray may be designed to transfer bite turbos that vary in size, shape, and the amount of bite opening or functional correction.

### INCORPORATION BY REFERENCE TO ANY PRIORITY AND RELATED APPLICATIONS

This application is a continuation of U.S. application Ser. No. 17/672,083, filed Feb. 15, 2022, which is a continuation of U.S. application Ser. No. 16/804,734, filed Feb. 28, 2020, which claims the priority benefit of U.S. Provisional Application No. 62/812,609, filed Mar. 1, 2019, which are hereby incorporated by reference in their entireties herein and made a part of this specification.

Any and all applications for which a foreign or domestic priority claim is identified in the Application Data Sheet as filed with the present application are hereby incorporated by reference under 37 CFR 1.57.

### BACKGROUND

### Field of the Invention

This invention relates in some aspects to orthodontic appliances, including orthodontic brackets, orthodontic auxiliaries, bite turbos, and indirect bonding trays.

### SUMMARY

In some embodiments, disclosed herein is an indirect bonding tray for transferring orthodontic brackets, orthodontic auxiliaries, and/or bite turbos to a patient's teeth. The indirect bonding tray has a tray having a lingual, occlusal, and buccal side and designed to be seated on at least a portion of the patient's dentition. The tray may include at least one well corresponding to at least one orthodontic bracket, orthodontic auxiliary, or bite turbo. An orthodontic bracket, orthodontic auxiliary, or bite turbo(s) may be secured within its corresponding well of the indirect bonding tray. These wells can be located on any tooth surface allowing for transfer of an orthodontic bracket, orthodontic auxiliary, or bite turbo to any tooth surface. The indirect bonding tray can include a plurality of wells corresponding to a plurality of orthodontic brackets, orthodontic auxiliaries, and/or bite turbos.

In some embodiments, disclosed herein is an indirect bonding tray that may transfer different types of bite turbos for various functions to aid with tooth movement. The bite turbo may be a pre-fabricated bite turbo or may be formed by a moldable material. The pre-fabricated bite turbo may be composed of various materials such as metal or composite. The moldable material may also be made of various materials such as composites, adhesives, or gels. The moldable material may be cured by a variety of methods such as by light or chemicals. The bite turbos may be shaped to interact with teeth and/or other bite turbos to aid with tooth movement such as overbite, crossbite, and/or sagittal correction.

In some embodiments, disclosed herein are various methods to fabricate an indirect bonding tray to transfer orthodontic brackets, orthodontic auxiliaries, and/or bite turbo onto teeth. The indirect bonding tray may be digitally designed and 3D printed. Another embodiment may include, a 3D printed model of teeth with digitally placed placeholder orthodontic brackets, orthodontic auxiliaries, and/or bite turbo. An indirect bonding tray may then be formed by using a moldable material which may be placed around the 3D printed physical model. Another embodiment may include a physical model, which may be fabricated by various methods such as poured in stone or rapid prototyped. The orthodontic brackets, orthodontic auxiliaries, and/or bite turbo may be temporarily placed on the physical model. A moldable material may be placed around this physical model with temporarily placed orthodontic brackets, orthodontic auxiliaries, and/or bite turbos. An indirect bonding tray may then be fabricated by placing a moldable material over this model.

In some embodiments, an indirect bonding tray is disclosed that can have wells sized and configured to house orthodontic brackets, bite turbos, and/or orthodontic auxiliaries for transferring to a patient's teeth.

In some embodiments, the indirect bonding tray is composed of a single piece, sections, or sections for individual teeth.

In some embodiments, the indirect bonding tray can be composed of sections that vary in size, position, number of sections, and number of teeth per section

In some embodiments, the indirect bonding tray can be digitally designed and 3D printed.

In some embodiments, the indirect bonding tray can be fabricated using a moldable material on a digitally designed, 3D printed bonding model with non-functional placeholders for orthodontic brackets, bite turbos, and/or orthodontic auxiliaries.

In some embodiments, the indirect bonding tray can be fabricated using a moldable material on a physical or 3D printed bonding model that has temporarily placed functional orthodontic brackets, bite turbos, and/or orthodontic auxiliaries.

In some embodiments, the indirect bonding tray can transfer orthodontic brackets, bite turbos, and/or orthodontic auxiliaries to any tooth surface.

In some embodiments, the indirect bonding tray can transfer a bite turbo that can aid in functional tooth movement to facilitate crossbite or sagittal correction.

In some embodiments, the indirect bonding tray can transfer bite turbos that can be digitally designed to vary in size and shape based on an amount of bite opening or functional correction.

In some embodiments, the indirect bonding tray can transfer orthodontic brackets, bite turbos, and orthodontic auxiliaries composed of any material.

In some embodiments, a method of manufacturing an indirect bonding tray is disclosed for transferring orthodontic brackets, bite turbos, and/or orthodontic auxiliaries to a patient's teeth. The method can include 3D printing a model of a patient's teeth. The method can include positioning placeholders for orthodontic brackets, bite turbos, and/or orthodontic auxiliaries on the 3D model of the patient's teeth. The method can include forming an indirect bonding by placing a moldable material over the model of the patient's teeth with the non-functional placeholders. The method can include curing the indirect bonding tray. The method can include placing orthodontic brackets, bite turbos, and/or orthodontic auxiliaries in respective wells formed in the indirect bonding tray by the placeholders.

In some embodiments, the method can include digitally designing the 3D model of the patient's teeth.

In some embodiments, the bite turbos are configured to aid in functional tooth movement to facilitate crossbite or sagittal correction.

In some embodiments, the orthodontic auxiliaries include power arms and/or buttons.

In some embodiments, positioning the placeholders can include positioning nonfunctional placeholders.

In some embodiments, positioning the placeholders can include positioning functional placeholders.

### BRIEF DESCRIPTION OF THE DRAWINGS

These drawings are illustrative embodiments and do not present all possible embodiments of this invention.

FIG. 1A illustrates a gingival auxiliary view of an embodiment of an indirect bonding tray with wells for lingual orthodontic brackets, buccal orthodontic buttons, and occlusal bite turbos.

FIG. 1B illustrates a gingival auxiliary view of an embodiment of an indirect bonding tray loaded with lingual orthodontic brackets, buccal orthodontic buttons, and occlusal bite turbos.

FIG. 1C illustrates an occlusal view of an embodiment of a single piece indirect bonding tray seated on the teeth to transfer lingual orthodontic brackets, buccal orthodontic buttons, and occlusal bite turbos.

FIG. 1D illustrates an occlusal view of an embodiment of a sectioned indirect bonding tray seated on the teeth to transfer lingual orthodontic brackets, buccal orthodontic buttons or power arms, and occlusal bite turbos.

FIG. 1E illustrates an auxiliary view of an embodiment of a single tooth indirect bonding tray loaded with a lingual orthodontic bracket, buccal orthodontic button, and occlusal bite turbo.

FIG. 1F illustrates an occlusal view of a 3D printed bonding model with non-functional placeholders for the orthodontic brackets, buttons, and bite turbo. An indirect bonding tray may be fabricated using this 3D printed model.

FIG. 1G illustrates an occlusal view of a physical model with temporarily placed functional lingual brackets, orthodontic buttons, and occlusal bite turbos. An indirect bonding tray may be fabricated using this model.

FIG. 2A illustrates a cross-sectional side (or mesial/distal) view of an embodiment of an indirect bonding tray that can transfer an anterior lingual bite turbo and a buccal bracket.

FIG. 2B illustrates a cross-sectional side (or mesial/distal) view of an embodiment of an indirect bonding tray that can transfer an anterior crossbite incisal bite turbo and a lingual bracket.

FIG. 2C illustrates a cross-sectional side (or mesial/distal) view of an embodiment of an indirect bonding tray that can transfer a posterior crossbite bite turbo.

FIG. 2D illustrates a frontal (or buccal) view of an embodiment of an indirect bonding tray that can transfer a sagittal corrector bite turbo.

### DETAILED DESCRIPTION

Disclosed herein are systems and methods that integrate a bite turbo in indirect bonding tray. Bite turbos are buildups of composite that are used to create space between teeth and/or prevent brackets from colliding when a patient bites down.

Indirect bonding (IDB) trays have traditionally been used in orthodontics to transfer the planned position of solely orthodontic brackets from a physical or digital study model to a patient's teeth. The IDB tray will include a number of “wells” or “indentations” that the orthodontic bracket can be placed into and can then be transferred to the patient's tooth. Other auxiliaries used in orthodontics such as bite turbos, buttons, or power arms are typically direct bonded to the teeth which requires more chair time from the clinician.

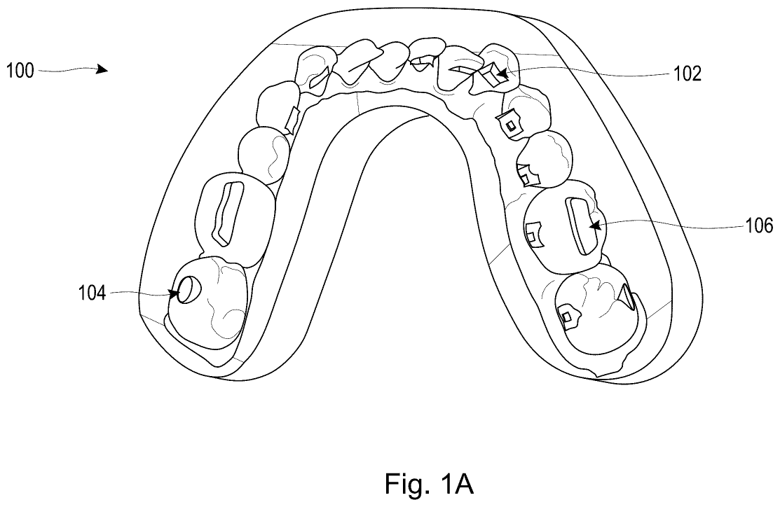

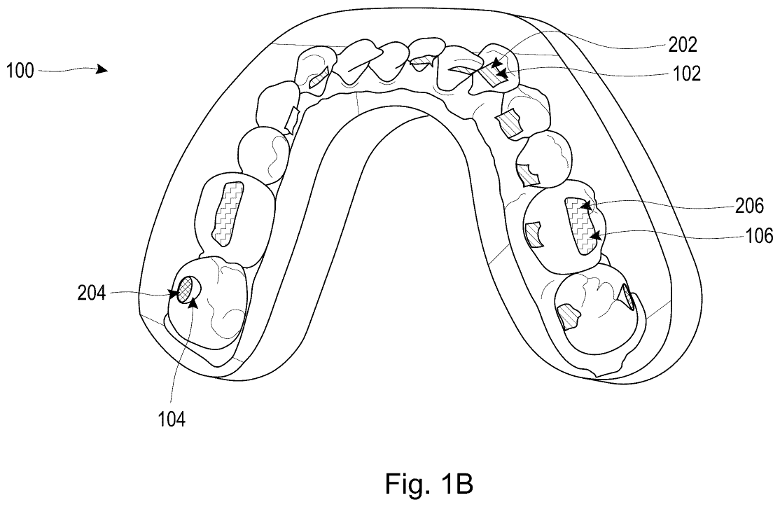

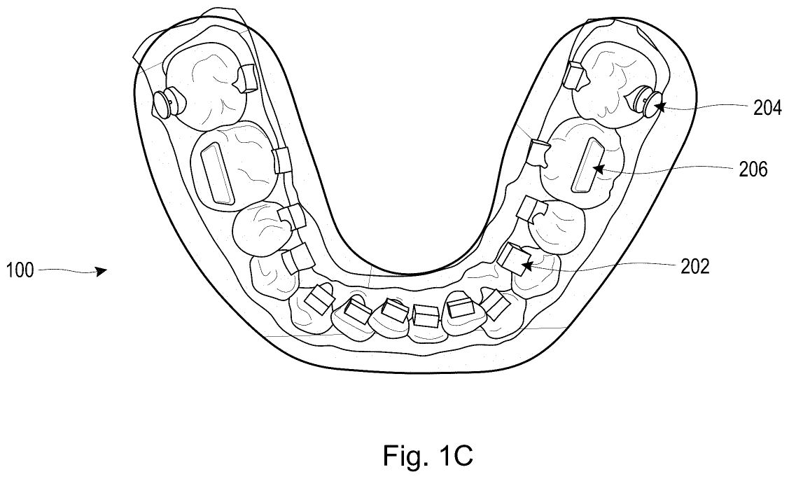

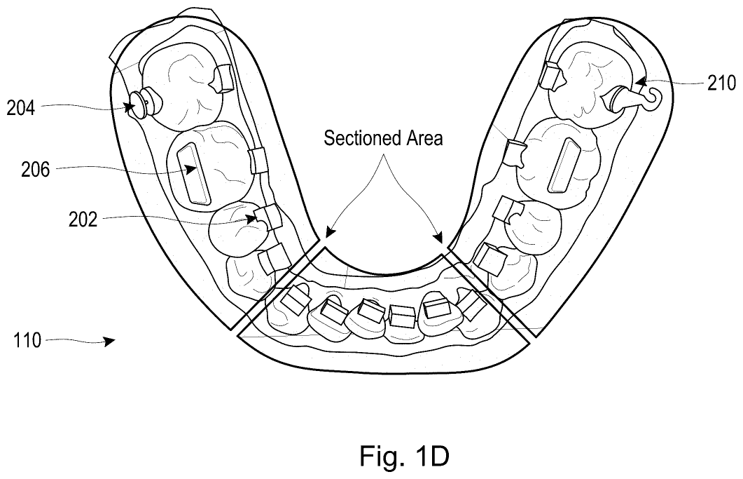

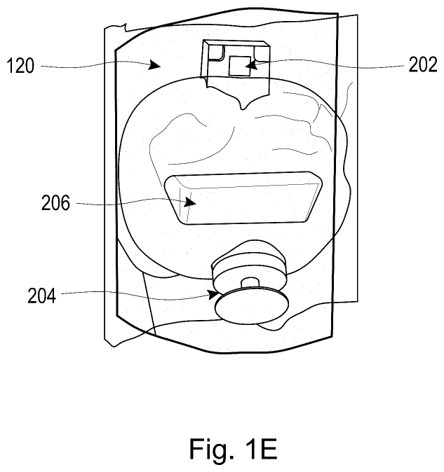

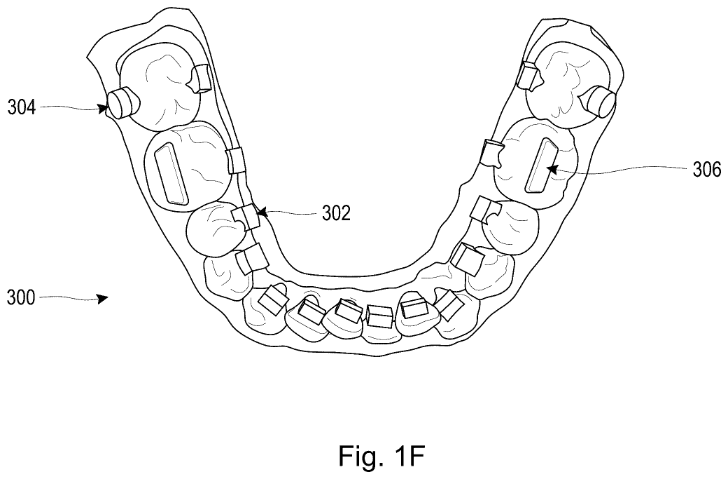

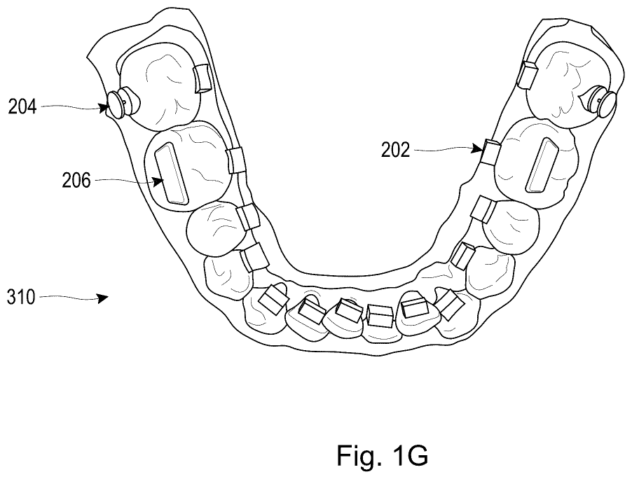

In some embodiments, disclosed herein are IDB trays that include wells configured and shaped to house orthodontic brackets, bite turbos, and/or orthodontic auxiliaries such as buttons or power arms. FIGS. 1A-E illustrate embodiments with lingual orthodontic brackets, occlusal bite turbos, and buccal orthodontic auxiliaries. FIG. 1A illustrates a gingival auxiliary view of an indirect bonding tray 100. The indirect bonding tray 100 can include one or more lingual orthodontic bracket wells 102. The indirect bonding tray 100 can include one or more buccal orthodontic button wells 104. The indirect bonding tray 100 can include one or more occlusal orthodontic bracket wells 106. The illustrated indirect bonding tray 100 includes lingual orthodontic bracket wells 102 for each tooth, occlusal bite turbo wells 106 on the first molars, and buccal orthodontic button wells 104 on the second molars. Other locations of the wells are contemplated. The indirect bonding tray 100 can be formed of a single piece. The indirect bonding tray 100 can be formed of multiple pieces.

FIG. 1B illustrates a gingival auxiliary view of the indirect bonding tray 100 loaded with lingual orthodontic brackets 202 on each tooth. The lingual orthodontic brackets 202 are loaded into the lingual orthodontic bracket wells 102. FIG. 1B illustrates a gingival auxiliary view of the indirect bonding tray 100 loaded with buccal orthodontic buttons 204 on the second molars. The buccal orthodontic buttons 204 are loaded in the buccal orthodontic button wells 104. FIG. 1B illustrates a gingival auxiliary view of the indirect bonding tray 100 loaded with occlusal bite turbos 206. The occlusal bite turbos 206 are loaded in the occlusal orthodontic bracket wells 106.

FIG. 1C illustrates an occlusal view of the single piece indirect bonding tray 100 seated on the teeth to transfer lingual orthodontic brackets 202 on each tooth, occlusal bite turbos 206 on the first molars, and buccal orthodontic buttons 204 on the second molars. While lingual orthodontic brackets 202, occlusal bite turbos 206, and buccal orthodontic buttons 204 are shown, the indirect bonding tray 100 can include or exclude any combination of these features. While lingual orthodontic brackets 202 are shown for each tooth, other configurations are contemplated.

FIG. 1D illustrates a sectioned indirect bonding tray 110. The sectioned indirect bonding tray 110 can include any of the features of indirect bonding tray 100. FIG. 1D illustrates an occlusal view of the indirect bonding tray 110 seated on the teeth to transfer lingual orthodontic brackets 202 on each tooth, occlusal bite turbos 206 on the first molars, buccal orthodontic button 204 on the lower right second molar. The indirect bonding tray 110 is seated on the teeth to transfer a buccal power arm 210 on the lower left second molar. The indirect bonding tray 110 has been sectioned into three pieces.

FIG. 1E illustrates a single tooth indirect bonding tray 120. The single tooth indirect bonding tray 120 is seated on a second molar. FIG. 1E illustrates an occlusal view of the single tooth indirect bonding tray 120 to transfer a lingual orthodontic bracket 202, occlusal bite turbo 206, and buccal orthodontic button 204.

The IDB trays 100, 110, 120 may transfer its components as a single piece, in sections, or to individual teeth as illustrated in FIGS. 1C-E. The indirect bonding tray sections may vary in size, position, number of sections, and number of teeth per section.

IDB trays that can transfer orthodontic brackets, bite turbos, and auxiliaries may be fabricated in various ways. The IDB tray may be digitally designed and 3D printed, and the corresponding orthodontic brackets, orthodontic auxiliaries, and/or bite turbos may be placed in the 3D printed wells. The indirect bonding tray may be 3D printed for an individual tooth, for a section of any number of teeth, or for the entire arch.

FIG. 1F illustrates an embodiment of a bonding model 300 with non-functional placeholder brackets, bite turbos, and auxiliaries that may be 3D printed, in some cases all out of the same material. FIG. 1F illustrates an occlusal view of the 3D printed bonding model 300. The model 300 includes non-functional placeholders for features such as lingual orthodontic brackets 302, buccal orthodontic buttons 304, and/or occlusal bite turbos 306, although others can be included. An indirect bonding tray may be fabricated using this bonding model 300. The non-functional placeholders can include the same size or shape of the corresponding features, such as a 3D outline. An IDB tray may then be fabricated by placing a moldable material over this model 300. Orthodontic brackets, orthodontic auxiliaries, and/or bite turbos may be placed in their corresponding wells formed by the moldable material.

FIG. 1G illustrates an embodiment of a bonding model with functional orthodontic brackets, bite turbos, and auxiliaries temporarily placed on a stone or 3D printed model. FIG. 1G illustrates an occlusal view of a bonding model 310 that includes temporarily placed functional lingual orthodontic brackets 202, buccal orthodontic buttons 204, and occlusal bite turbos 206. An indirect bonding tray may be fabricated using this bonding model. An IDB tray may then be fabricated by placing a moldable material over this model 310. After the moldable material is cured, the indirect bonding tray may be removed from the physical model with and/or without the orthodontic brackets, orthodontic auxiliaries, and/or bite turbos. Any orthodontic bracket, orthodontic auxiliary, and/or bite turbo that was not directly transferred from the physical model may be placed into the wells of the indirect bonding tray. The moldable material may be cured by a variety of methods such as by light or chemicals. This moldable material may be a variety of materials such as polyvinyl siloxane or a flowable adhesive. IDB trays made by the moldable material may be cut into sections or for individual teeth.

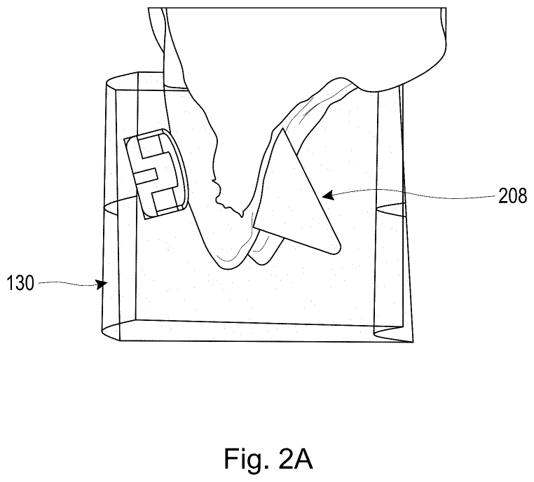

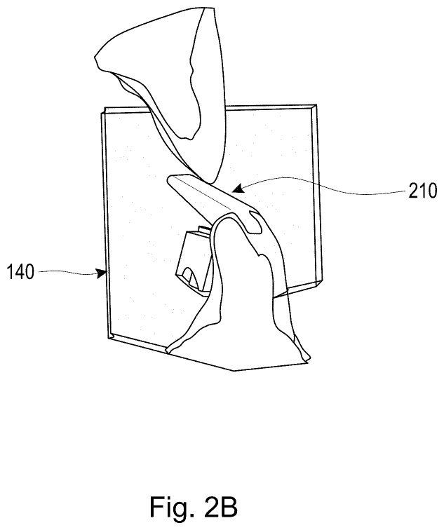

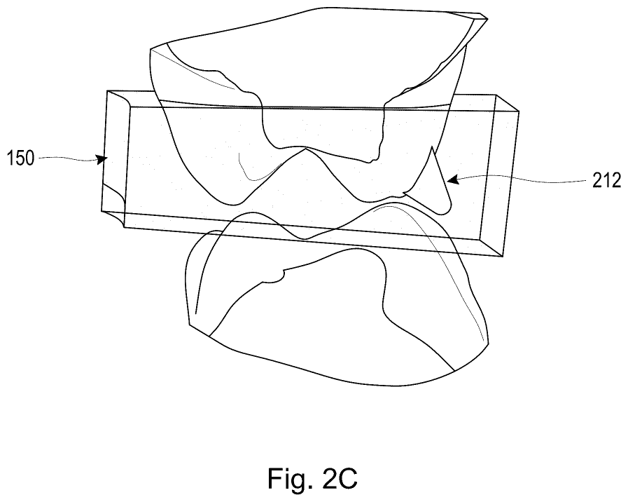

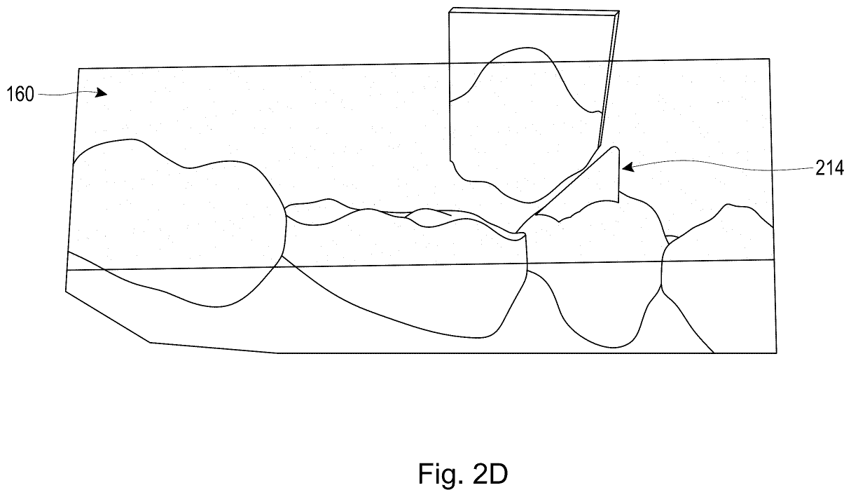

In some embodiments, disclosed herein are IDB trays with bite turbos placed on other tooth surfaces than the occlusal surface as shown in FIG. 1A-G. FIG. 2A illustrates an embodiment of an indirect bonding tray 130 that can transfer a lingual bite turbo 208 to an anterior tooth. A lingual bite turbo 208 on an upper anterior tooth promotes disarticulation of the bite which may help with deep bite correction.

FIG. 2B illustrates an embodiment of an indirect bonding tray 140 that can transfer an incisal bite turbo 210 to an anterior tooth. This incisal bite turbo 210 may be placed on a lower anterior tooth and can be beveled to help correct an anterior crossbite. When the upper incisors occlude with the beveled surface of the incisal bite turbo, it may induce proclination of the upper incisor and retroclination of the lower incisor.

FIG. 2C illustrates an embodiment of an indirect bonding tray 150 that can transfer a bite turbo 212 on a posterior tooth that is beveled to help correct a posterior crossbite. The posterior crossbite turbo 212 may induce the necessary buccal crown tip or lingual crown tip on the upper and lower molar to correct a posterior crossbite.

FIG. 2D illustrates an embodiment of an indirect bonding tray 160 that can transfer a bite turbo 214 that can help with sagittal correction. The bite turbo 214 may be positioned and beveled to allow disarticulation and repositioning of the occluding premolars to slide along the beveled surfaces aiding in sagittal correction acting similar to an orthodontic functional appliance.

In some embodiments, disclosed herein are IDB trays in which the orthodontic brackets, bite turbos, and orthodontic auxiliaries have been digitally designed for optimal placement for efficient tooth movement. The size, shape, and the amount of bite opening or functional correction may be programmed into the bite turbo design. These IDB trays may transfer orthodontic brackets, bite turbos, and orthodontic auxiliaries composed of any material.

Additional information can be found in U.S. Pub. No. 2018/0153651 published Jun. 7, 2018, which is incorporated by reference in its entirety. The bonding systems can include any of the features described in the Appendix. The bonding systems can be used in any methods described in the Appendix.

It is intended that the scope of this present invention herein disclosed should not be limited by the particular disclosed embodiments described above. This invention is susceptible to various modifications and alternative forms, and specific examples have been shown in the drawings and are herein described in detail. This invention is not limited to the detailed forms or methods disclosed, but rather covers all equivalents, modifications, and alternatives falling within the scope and spirit of the various embodiments described and the appended claims.

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “tying a tie onto an orthodontic bracket” includes “instructing the tying of a tie onto an orthodontic bracket.” The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

1. (canceled)

2. A method of forming an indirect bonding (IDB) tray with a custom bite turbo, the method comprising:
creating a digital 3D model of a patient's teeth;
designing a digital custom bite turbo that is sized and shaped based on an amount of bite correction to be performed;
positioning the digital custom bite turbo on a digital tooth of the digital 3D model of the patient's teeth;
designing a digital IDB tray with a digital well corresponding to the positioning, size, and shape of the digital custom bite turbo;
forming a physical IDB tray corresponding to the digital IDB tray, the physical IDB tray having a physical well corresponding to the digital well;
flowing a moldable material into the physical well; and
curing the moldable material to form a custom physical bite turbo corresponding to the digital custom bite turbo.

3. The method of claim 2, further comprising:
designing a second digital custom bite turbo that is sized and shaped based on an amount of bite correction to be performed;
positioning the second digital custom bite turbo on a second digital tooth of the digital 3D model of the patient's teeth;
designing the digital IDB tray with a second digital well corresponding to the positioning, size, and shape of the second digital custom bite turbo;
forming the physical IDB tray corresponding to the digital IDB tray, the physical IDB tray having a second physical well corresponding to the second digital well;
flowing the moldable material into the second physical well; and
curing the moldable material to form a second custom physical bite turbo corresponding to the second digital custom bite turbo.

4. The method of claim 2, wherein the physical IDB tray comprises a second well configured to receive an orthodontic bracket.

5. The method of claim 2, wherein forming the physical IDB tray comprises 3D printing the IDB tray.

6. The method of claim 2, wherein forming the physical IDB tray comprises flowing another moldable material over a physical model of one or more of the patient's teeth.

7. The method of claim 2, wherein curing the moldable material to form the custom physical bite turbo comprises curing with light.

8. The method of claim 2, wherein curing the moldable material to form the custom physical bite turbo comprises curing with a chemical.

9. The method of claim 2, wherein the moldable material comprises a composite.

10. The method of claim 2, wherein the moldable material comprises an adhesive.

11. The method of claim 2, wherein the physical IDB tray corresponds to a single tooth.

12. The method of claim 2, wherein the physical IDB tray corresponds to a section of a dental arch of the patient.

13. The method of claim 2, wherein the physical IDB tray corresponds to a plurality of teeth.

14. A method of forming a bite turbo on a tooth of a patient, the method comprising:
flowing a moldable material into a well of an indirect bonding tray;
placing the indirect bonding tray over a tooth with the moldable material in the well;
curing the moldable material to form the bite turbo on the tooth of the patient to aid in functional tooth movement to facilitate crossbite or sagittal correction; and
removing the indirect bonding tray from the tooth of the patient.

15. the method of claim 14, further comprising:
flowing the moldable material into a second well of the indirect bonding tray;
placing the indirect bonding tray over a second tooth with the moldable material in the second well;
curing the moldable material to form a second bite turbo on the second tooth of the patient to aid in functional tooth movement to facilitate crossbite or sagittal correction; and
removing the indirect bonding tray from the second tooth of the patient.

16. The method of claim 14, wherein the indirect bonding tray comprises a second well configured to receive an orthodontic bracket.

17. The method of claim 14, wherein curing the moldable material comprises curing with light.

18. The method of claim 14, wherein curing the moldable material comprises curing with a chemical.

19. The method of claim 14, wherein the moldable material comprises a composite.

14. The method of claim 14, wherein the moldable material comprises an adhesive.

21. The method of claim 14, wherein the indirect bonding tray corresponds to a single tooth.
